(19) United States
(12) Patent Application Publication
(10) Pub. No.: US 2026/0217236 A1
(43) Pub. Date: Jul. 30, 2026

(54) ARRANGEMENT FOR EXTENDING THE RANGE OF AN ELECTRIC VEHICLE

(71) Applicant: AUDI AG, Ingolstadt (DE)

(72) Inventors: Paul BÖCKENHOFF, Ingolstadt (DE); Alexander GUMMER, Ingolstadt (DE)

(21) Appl. No.: 19/462,824

(22) Filed: Jan. 28, 2026

(30) Foreign Application Priority Data
Jan. 30, 2025 (DE) 102025103380.3

(51) Int. Cl. B60W 20/12; B60K 15/067; B60L 50/62; B60W 10/26; B60W 20/13

(52) U.S. Cl. CPC B60W 20/12; B60K 15/067; B60L 50/62; B60W 10/26; B60W 20/13; B60W 2510/244; B60W 2520/10; B60W 2710/244

(57) ABSTRACT

An arrangement for extending the range of an electric vehicle is disclosed, and may include a generator module configured to generate electrical energy, at least one tank module configured to provide a fuel for the generator module, and at least one control unit configured to control and/or regulate the generator module. The generator module and the tank module may be configured to be used for extending the range in the electric vehicle and may be connected to the electric vehicle in a data-conducting and/or energy-conducting manner by at least one interface. The generator module and/or the tank module may be configured to be removable from the electric vehicle by a user of the electric vehicle. A vehicle having such an arrangement for extending the range of the vehicle is also disclosed.

### BACKGROUND

### TECHNICAL FIELD

The present disclosure relates to an arrangement for extending the range of an electric vehicle, particularly electric vehicles including a generator module for generating electrical energy and at least one tank module for providing a fuel for the generator module.

### DESCRIPTION OF THE RELATED ART

The development of electromobility has led to a large number of battery electric vehicles (BEVs) or electric vehicles that are environmentally friendly and future-oriented. The limited range of electric vehicles is a decisive factor that influences the suitability and acceptance of electric vehicles for everyday use.

Despite the steady growth of the electric vehicle industry, the range of electric vehicles is insufficient compared to conventional combustion vehicles. The usual maximum range of a fully fueled gasoline vehicle is usually twice as high as the maximum range of an electric vehicle. This discrepancy is a key obstacle to the widespread acceptance of electric vehicles.

Range extenders to increase the range are already known, which are installed in electric vehicles and operated when required. For example, range extenders in the form of combustion engines with an attached generator are known to generate electrical energy from gasoline or diesel. In addition to fuel cells and additional batteries as range extenders, free-piston linear generators and micro gas turbines are also known to generate electrical energy in electric vehicles. Another concept for range extension is known from CN103223850A, which proposes an additional wheel driven by an internal combustion engine as a redundant drive.

The solutions known to date for extending the range of electric vehicles are devices permanently installed in the electric vehicle. This permanently increases the vehicle mass, regardless of the actual use of the range extender. The components of the range extender also reduce the possible usable volume in the electric vehicle, so that the trunk volume or frunk volume is reduced. CN103223850A, for example, describes a range extender arranged in a trunk.

FR2958580A1 discloses a light vehicle with a range extender. The range extender is arranged in the front engine compartment together with the transmission and the electric motor.

### BRIEF SUMMARY

The present disclosure is directed to a vehicle which may enable a situation-dependent increase in range and, when not in use, an increase in usable volume.

According to an aspect of the present disclosure, an arrangement for extending the range of an electric vehicle is provided. The arrangement may comprise a generator module for generating electrical energy and at least one tank module for providing a fuel for the generator module. Furthermore, at least one control unit for controlling and/or regulating the generator module may be provided. The control unit may be arranged outside the generator module or integrated into the generator module.

The generator module and the tank module are configured to be used to extend the range in the electric vehicle and may be connected to the electric vehicle via at least one interface in a data-conducting and/or energy-conducting manner. The at least one interface may also form a connection between the generator module and the tank module. In addition, at least one interface may be provided for supplying air to the generator module and for releasing exhaust gases into the vehicle environment.

The at least one interface may be configured for a transfer of electrical energy and/or for an exchange of fluids and/or for an exchange of measurement data.

The generator module and/or the tank module may be configured such that the generator module and/or the tank module may be removed from the electric vehicle by a user of the electric vehicle.

The arrangement according to the present disclosure may function as a range extender system and may be independently installed and removed from the electric vehicle by the user as required and depending on the situation. If the longer range is not required for daily use, for example, the generator module and/or the tank module may be removed to optimize the weight and increase the usable volume in the frunk or trunk.

By separating the system into a generator module and a tank module, the weight of the individual components to be installed may be reduced and made manageable for the user. Therefore, any visits to a workshop may be unnecessary.

Furthermore, the arrangement may also be used to travel longer distances without intermediate charging stops or in remote areas with an inadequate charging infrastructure.

According to a further aspect of the present disclosure, a vehicle is provided which is configured as an electric vehicle. The vehicle comprises an arrangement according to the present disclosure. A generator module and/or a tank module of the arrangement may be removed for operation of the electric vehicle without extending the range. To operate the electric vehicle with an extended range, the generator module and the tank module may be inserted into the electric vehicle by the user. The generator module and tank module may be removed and inserted by the user without additional help or auxiliary equipment.

When the generator module and the tank module are inserted, a connection may be automatically established with at least one interface of the vehicle via a respective interface of the generator module and/or the tank module. Accordingly, the connection to the at least one interface may be automatically disconnected or released again when the generator module and the tank module are removed.

The two main components, namely the generator module and the tank module, may each be configured as a self-contained module unit with defined interfaces to each other and to the vehicle. This division or separation of the arrangement may enable a modularity of the arrangement to be realized, which may be adapted to the geometry of the frunk or trunk of the vehicle. Depending on requirements, a generator module with a smaller tank module may also be installed in a large frunk or trunk, creating additional storage space.

The weight of a range extender configured as a complete system, including a tank and motor unit, may prevent easy installation or removal by the user. By separating the generator module and the tank module, removal and installation may be carried out independently by one person or, if necessary, by two people, as needed.

In some exemplary embodiments, the control unit is installed in the generator module, wherein the tank module may be coupled directly to the generator module via a first interface. Measurement data and/or fuel may also be transferred between the tank module and the generator module via the first interface. For example, the tank module may have sensors in the form of temperature sensors, conductivity sensors, fill level sensors and the like, whereby the generator module may also determine a quantity of fuel contained in the tank module in addition to a proper coupling of the tank module with at least one interface. For this purpose, the control unit may access the corresponding measurement data from the sensors of the tank module in order to implement an evaluation.

A direct coupling between the generator module and the tank module may also enable a particularly compact arrangement.

According to some embodiments, the generator module may be connected to at least one second interface and at least one third interface. The at least one second interface and the at least one third interface may be arranged on the vehicle side. The generator module may have interfaces or connections corresponding to the second interface and the third interface configured to enable coupling. The generator module may be configured to transmit electrical energy generated via the at least one second interface to the electric vehicle, such as to a traction battery of the electric vehicle. Furthermore, the generator module may be configured to establish a fluid-carrying connection with a vehicle environment and/or the electric vehicle via the at least one third interface.

The generator module may have an internal combustion engine and a generator with corresponding peripherals. The combustion engine of the generator module may be used to drive the generator to produce electrical energy to extend the range of the vehicle. In addition to the transmission of electrical energy, the second interface may also enable the transmission of data or measurement data, allowing the control unit to implement control and/or regulation of the generator module based on the measurement data received.

According to some exemplary embodiments, the generator module and/or the tank module may be inserted by the user in a trunk and/or underneath a trunk and/or in a frunk of the electric vehicle. By inserting the generator module and/or the tank module, a connection may be established with at least one vehicle-side interface.

The connection to the at least one vehicle-side interface may be made automatically or by the user subsequently connecting or plugging in connections or couplings.

The use of the arrangement in the frunk, due to the frunk’s location outside the passenger compartment, may enable well-insulated operation of the generator module, resulting in greater comfort during operation of the arrangement.

Furthermore, the waste heat from the generator module may be used for air conditioning the vehicle’s interior when required. Such a configuration may be particularly advantageous in cold outside temperatures, when the traction battery is under particular strain due to the high heating demand. Such a configuration may maximize the efficiency of the arrangement in relation to a primary energy source.

Operation of the arrangement may be configured to be particularly efficient and convenient if a networked and intelligent control device is provided that is configured control and/or regulate the generator module fully automatically. For example, the times at which the internal combustion engine of the generator module is switched on and off may be optimized depending on various vehicle parameters. According to some embodiments, the control unit is configured to activate or deactivate the generator module as a function of a vehicle speed and/or as a function of a planned trajectory of the electric vehicle. This means that operation of the internal combustion engine of the generator module may only be permitted at higher speeds, for example, above 80 km/h. The noise generated by the activated generator module may be less noticeable to the vehicle’s passengers due to the higher noise levels from wind and tires at higher driving speeds. To prevent the generator module from being switched on and off frequently, the optimum operating time for the generator module may be determined using navigation data, for example.

According to some embodiments, the control unit is configured to activate or deactivate the generator module as a function of the state of charge of a traction battery of the electric vehicle. This measure may maximize the efficiency of the arrangement, in particular if the generator module charges the traction battery of the electric vehicle when the SOC (State Of Charge) is low. The control unit may determine an optimum time for the charging based on the current state of charge of the traction battery, the anticipated energy requirement of the electric vehicle, and the driving profile according to navigation data.

According to some embodiments, the generator module may be activated by the control unit along a trajectory to a destination if the state of charge of the traction battery of the electric vehicle is not expected to be sufficient to reach a destination. The arrangement may therefore only be operated if additional energy is required to reach the destination entered in the electric vehicle’s navigation system or if the user manually specifies a minimum charge level when the destination is reached. The amount of energy determined from this information, which must be provided by the generator module during the journey, may be generated at an optimum time along the route or trajectory of the electric vehicle.

According to some embodiments, the generator module for generating energy may be controlled and/or regulated by the control unit as a function of the performance of the generator module and/or the fill level of the tank module. The dimensions of the tank module and/or the generator module may be limited in order to configure the arrangement as cost-efficiently as possible and to achieve a compact dimensioning of the arrangement. As a result, the power and the associated energy output of the generator module may be limited. The control unit may take into account this limitation of the maximum electrical energy that may be generated by the generator module, as well as the maximum time required to generate electrical energy by the generator module due to a limited capacity of the tank module, when controlling the generator module.

### BRIEF DESCRIPTION OF THE SEVERAL VIEWS OF THE DRAWINGS

FIG. 1 shows a perspective view of a portion of a vehicle with an arrangement according to an exemplary embodiment of the disclosure.

FIG. 2 shows top views of exemplary embodiments of frunks configured to receive a tank module and a generator module of the arrangement of FIG. 1.

### DETAILED DESCRIPTION

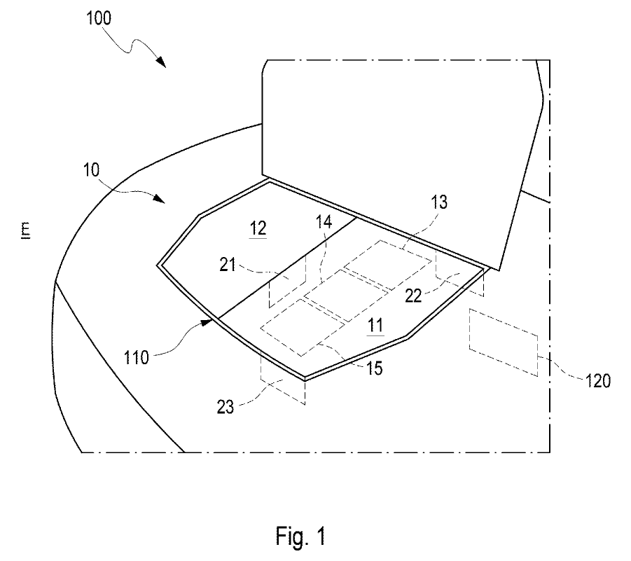

FIG. 1 shows a perspective depiction of a vehicle 100 with an arrangement 10 according to an exemplary embodiment of the present disclosure. The vehicle 100 is configured as an electric vehicle and may have a frunk 110. The frunk 110 normally functions as a storage space or cargo space and is shown open in FIG. 1. The arrangement 10 is inserted in the frunk 110 in FIG. 1. If the space in the frunk 110 is to be used as storage space, the arrangement 10 may be removed from the frunk 110 by a user of the vehicle 100.

The arrangement 10 may be used to extend the range of the vehicle 100 and may supply a traction battery 120 of the vehicle 100 with electrical energy. For this purpose, the arrangement 10 may have a generator module 11 configured to generate electrical energy and at least one tank module 12 configured to provide a fuel for the generator module 11. The fuel may be gasoline, diesel, ethanol and the like.

Furthermore, a control unit 13 configured to control and/or regulate the generator module 11 may be provided, which may be configured as a component of the generator module 11. In some embodiments, the control unit 13 is a controller having a microprocessor that includes a processor and a memory storing instructions that, when executed by the processor, cause the microprocessor to perform the acts of the control unit 13 described herein.

FIG. 1 shows the generator module 11 and the tank module 12 in an inserted state. When removed from the frunk 110, a cargo volume or usable volume of the frunk 110 may be used for other purposes.

In the exemplary embodiment shown, the generator module 11 has an internal combustion engine 14 and a generator 15 with corresponding peripherals (not depicted). In some embodiments, all other components required for power generation may be integrated into the generator module 11. This also includes auxiliary units with an on-board electrical system within the module. Alternatively, a connection may be made to an on-board electrical system of the vehicle 100 if a generator module 11 is used.

Tank module 12 and generator module 11 may be configured in shape and dimensions thereof to the shape and dimensions of frunk 110. The generator module 11 and the tank module 12 may be removed and installed separately or independently of each other, enabling ease of handling by the user because each of the modules 11, 12 may be light enough to be lifted into the frunk 110 by one or two adults.

The tank module 12 may be coupled directly to the generator module 11 via a first interface 21. Measurement data and/or fuel may also be transferred between the tank module 12 and the generator module 11 via the first interface 21.

The electrical energy generated by the generator 15 may be transmitted to the traction battery 120 of the vehicle 100 via a second interface 22. The second interface 22 may also enable data transfer between the vehicle 100 or a vehicle-side control unit (not depicted) and the control unit 13 of the generator module 11.

A third interface 23 may establish a fluid-carrying connection between the generator module 11 and a vehicle environment E and/or the vehicle 100.

Interfaces 21, 22, 23 may enable tool-free and process-safe assembly of the tank module 12 and the generator module 11 with the vehicle 100 by the user. In addition to the fastening of the generator module 11, the media supply and removal may also be realized. The media supply and removal may include, for example, the supply of fresh air for cooling the internal combustion engine 14 and as supply air to the generator module 11 itself, removal of the cooling air, removal of the combustion exhaust gases (the exhaust gas aftertreatment can also be part of the generator module 11), transmission of the electrical energy to the traction battery 120, and a connection to the vehicle electronics, for example to receive navigation data.

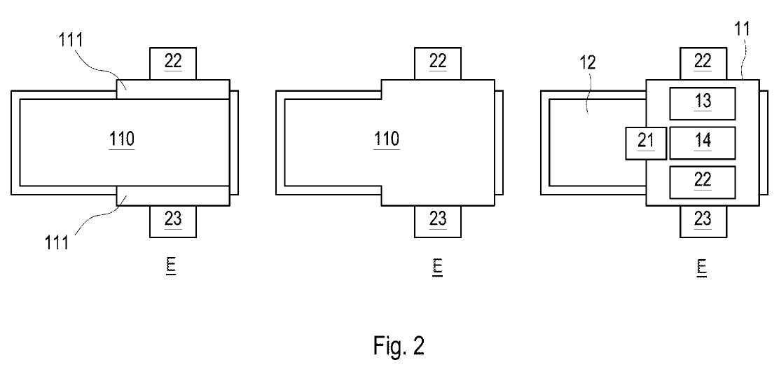

FIG. 2 shows several top views of the frunk 110 to illustrate an insertion of the tank module 12 and the generator module 11 of the arrangement 10 from FIG. 1. If an extended range is not required, the arrangement 10 may be removed from the frunk 110. The second interface 22 and the third interface 23 may be configured as part of the vehicle 100 by way of example. These interfaces 22, 23 may also serve as fastening devices, for example, by engaging, and may be concealed by covering parts 111 for unrestricted use of the frunk 110. The state of vehicle 100 utilizing covering parts 111 is illustrated in the image on the left of FIG. 2.

The vehicle-side interfaces 22, 23 may be accessible by removing the covering parts 111. The generator module 11 and the tank module 12 may then be inserted into the frunk 110 to extend the range of the vehicle 100. By inserting the generator module 11, the generator module 11 may simultaneously be coupled to the second interface 22 and the third interface 23. Subsequent insertion of the tank module 12 may establish a connection to the generator module 11 via the first interface 21.

German patent application no. 102025103380.3, filed January 30, 2025, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. An arrangement for extending the range of an electric vehicle, comprising:
a generator module configured to generate electrical energy;
at least one tank module configured to provide a fuel for the generator module; and
at least one control unit configured to control and/or regulate the generator module;
wherein the generator module and the tank module are configured to be used for extending the range in the electric vehicle and are connected to the electric vehicle in a data-conducting and/or energy-conducting manner by at least one interface, and
wherein the generator module and/or the tank module are configured to be removable from the electric vehicle by a user of the electric vehicle.

2. The arrangement according to claim 1, wherein the control unit is installed in the generator module,
wherein the tank module is configured to be coupled directly to the generator module via a first interface, and
wherein the first interface is configured such that measurement data and/or fuel can be transmitted between the tank module and the generator module via the first interface.

3. The arrangement according to claim 2, wherein the generator module is configured to be connected to at least one second interface and to at least one third interface,
wherein the generator module is configured to transmit generated electrical energy via the at least one second interface to the electric vehicle, and
wherein the generator module is configured to establish a fluid-carrying connection to a vehicle environment and/or the electric vehicle via the at least one third interface.

4. The arrangement according claim 3, wherein the generator module is configured to transmit generated electrical energy via the at least second interface to a traction battery of the electric vehicle.

5. The arrangement according to claim 1, wherein the generator module and/or the tank module are configured to be inserted by the user in a trunk and/or underneath a trunk and/or in a frunk of the electric vehicle, and to establish a connection to at least one vehicle-side interface by insertion of the generator module and/or the tank module.

6. The arrangement according to claim 1, wherein the control unit is configured to activate or deactivate the generator module as a function of a vehicle speed of the electric vehicle and/or as a function of a planned trajectory of the electric vehicle.

7. The arrangement according to claim 1, wherein the control unit is configured to activate or deactivate the generator module as a function of a state of charge of a traction battery of the electric vehicle.

8. The arrangement according to claim 7, wherein the control unit is configured to activate the generator module along a trajectory to a destination by the control unit if a state of charge of the traction battery of the electric vehicle is not expected to be sufficient to reach the destination.

9. The arrangement according to claim 1, wherein the generator module for generating energy is configured to be controlled and/or regulated by the control unit as a function of a performance of the generator module and/or a fill level of the tank module.

10. A vehicle comprising:
an arrangement for extending the range of the vehicle including:
a generator module configured to generate electrical energy;
at least one tank module configured to provide a fuel for the generator module; and
at least one control unit configured to control and/or regulate the generator module;
wherein the generator module and the tank module are configured to be used for extending the range in the electric vehicle and are connected to the electric vehicle in a data-conducting and/or energy-conducting manner by at least one interface,
wherein the generator module and/or the tank module are configured to be removable from the vehicle by a user of the vehicle, such that the generator module and/or the tank module can be removed from the arrangement for operation of the vehicle without extending a range of the vehicle and can be inserted into the vehicle for operation of the vehicle with extending the range, and
wherein the vehicle is configured as an electric vehicle.
